(19) United States
(12) Patent Application Publication
(10) Pub. No.: US 2019/0297926 A1
(43) Pub. Date: Oct. 3, 2019

(54) CONTINUOUS POPCORN MACHINES AND ASSOCIATED SYSTEMS AND METHODS

(71) Applicant: C. Cretors & Company, Wood Dale, IL (US)

(72) Inventor: Charles D. Cretors, Lake Forest, IL (US)

(21) Appl. No.: 15/943,352

(22) Filed: Apr. 2, 2018

(51) Int. Cl. A23L 7/187

(52) U.S. Cl. CPC A23L 7/187; A23V 2300/24

(57) ABSTRACT

Popcorn machines and associated methods of manufacture and use are disclosed herein. In one embodiment, a popcorn machine includes a housing, and a corn mover and a trough positioned within the housing. The corn mover is rotatably mounted within the trough, and the trough can be fixed relative to the housing. The popcorn machine can further comprise a heat source and an air mover positioned within the housing. In operation, the air mover is configured to direct heated air from the heat source toward corn kernels moved through the trough by the corn mover.

### TECHNICAL FIELD

The following disclosure relates generally to popcorn machines and, more particularly, to popcorn machines having troughs that facilitate cleaning and inspection of components of the popcorn machines, and associated systems and methods.

### BACKGROUND

Popcorn machines are known in the art. One type of conventional popcorn machine makes popcorn by heating corn kernels in oil. Another type of popcorn machine, known as a “dry” popcorn machine, makes popcorn by heating corn kernels in hot air. In a “dry” popcorn machine, the corn kernels are subjected to a current of hot air to heat the kernels to the popping temperature. After popping the popcorn in the hot air, flavoring (e.g., butter, caramel, oil, etc.) can be added to the popcorn if desired. Popcorn machines using hot air to pop large quantities of popcorn are typically used for commercial purposes. In some instances, it can be difficult to inspect and/or clean some components of these machines.

### BRIEF DESCRIPTION OF THE DRAWINGS

FIG. 1 is an isometric view of a popcorn machine configured in accordance with an embodiment of the present technology.

FIG. 2 is a cross-sectional, isometric side view of the popcorn machine of FIG. 1 configured in accordance with embodiments of the present technology.

FIG. 3 is a side view of the popcorn machine of FIG. 1 configured in accordance with embodiments of the present technology.

### DETAILED DESCRIPTION

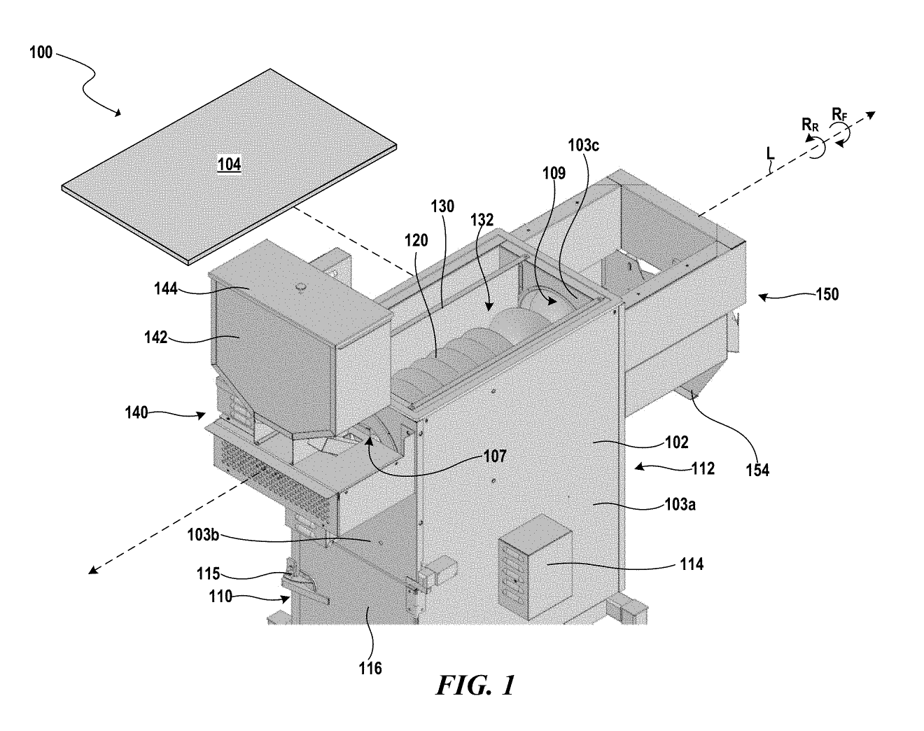

The following disclosure describes various embodiments of popcorn machines having troughs that facilitate inspection and/or cleaning of components of the popcorn machines, and associated systems and methods. In some embodiments, a popcorn machine configured in accordance with the present technology includes a perforated trough positioned at least partially within an interior portion of a housing. An auger can be positioned at least partially within the trough and rotatable to move ingredients (e.g., popcorn) through the trough. The popcorn machine can further include a heat source and an air mover. The air mover can be configured to direct heated air from the heat source through the perforated trough to heat the ingredients therein. Although several embodiments of the present technology can include all of these features, other embodiments may omit particular features, components and/or procedures. A person of ordinary skill in the relevant art, therefore, will understand that the present technology, which includes associated devices, systems, and methods, may include other embodiments with additional elements or steps, and/or may include other embodiments without several of the features or steps shown and described below with reference to FIGS. 1-3.

As discussed in further detail below, many existing popcorn machines do not provide for the efficient and/or easy inspection of the popping drum or popping chamber. For example, some existing popcorn machines include a screen (e.g., a perforated sheet) fixedly attached around an auger so that the screen and auger rotate together to move ingredients through the popcorn machine. The present technology includes several embodiments of popcorn machines and associated systems and methods that facilitate easy access to and/or inspection of components within the popcorn machine. Certain details are set forth in the following description and FIGS. 1-3 to provide a thorough understanding of various embodiments of the disclosure. To avoid unnecessarily obscuring the description of the various embodiments of the disclosure, other details describing well-known structures and systems often associated with popcorn machines, augers, heating sources, air movers, and the components or devices associated with the manufacture of conventional popcorn machines or augers are not set forth below. Moreover, many of the details and features shown in the Figures are merely illustrative of particular embodiments of the disclosure. Accordingly, other embodiments can have other details and features without departing from the spirit and scope of the present disclosure. In addition, the various elements and features illustrated in the Figures may not be drawn to scale. Furthermore, various embodiments of the disclosure can include structures other than those illustrated in the Figures and are expressly not limited to the structures shown in the Figures.

FIG. 1 is a partially exploded, isometric view of a popcorn machine 100 configured in accordance with an embodiment of the present technology. In several embodiments, the popcorn machine 100 can include one or more components, devices, and/or features that are the same as or at least generally similar to those described in: U.S. Pat. No. 8,201,492, filed Mar. 6, 2009, and titled “POPCORN MACHINES AND ASSOCIATED METHODS OF MANUFACTURE AND USE;” in U.S. patent application Ser. No. 15/821,654, filed Nov. 22, 2017, and titled “CONTINUOUS POPCORN MACHINES HAVING VARIABLE HEATING PROFILES AND ASSOCIATED SYSTEMS AND METHODS;” and/or in U.S. patent application Ser. No. 15/843,638, filed Dec. 15, 2017, and titled “POPCORN MACHINES HAVING PROCESS CHAMBERS OF INCREASING VOLUME, AND ASSOCIATED SYSTEMS AND METHODS;” each of which is incorporated herein by reference in its entirety.

In the illustrated embodiment, the popcorn machine 100 includes a cabinet or housing 102 having a first end 110, a second end 112, side covers 103 (only a first side cover 103a, a second side cover 103b, and a third side cover 103c are visible in FIG. 1), and a removable upper cover 104. The upper cover 104 is shown removed from the popcorn machine 100 for clarity of illustration. The second side cover 103b can include a door 116 that is openable via a handle 115 to allow access to an interior portion of the housing 102.

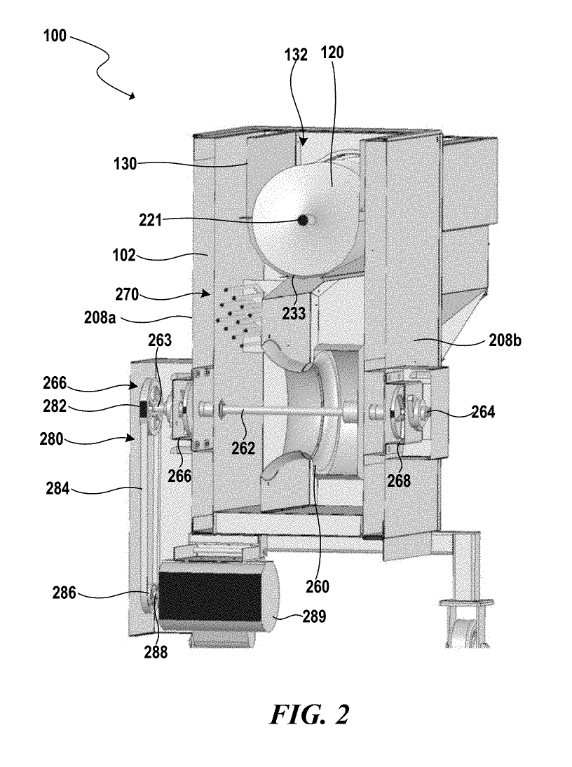

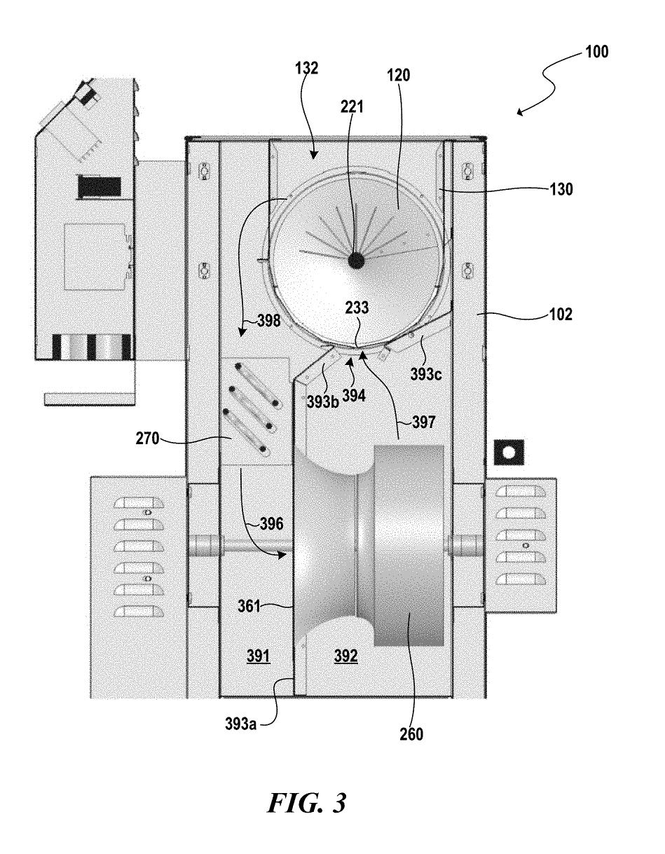

The housing 102 at least partially encloses a corn mover 120 (e.g., a screw conveyor, anauger, etc.) and a trough 130 (e.g., a perforated trough). More particularly, the trough 130 extends between the first and second ends 110, 112 of the housing 102 and, as best seen in FIGS. 2 and 3, the trough 130 is fixedly attached to the housing 102 and extends (e.g., wraps) around the corn mover 120 but is not attached to the corn mover 120, and defines a channel 132. In the illustrated embodiment, the trough 130 has a generally U-shape. In other embodiments, the trough 130 can have other shapes, and can extend around more or less of the auger 120. In some embodiments, the trough 130 can be formed from perforated sheet metal (e.g., a screen) that is approximately 35% open. In other embodiments, the trough 130 can be made from other suitable materials that are more or less than about 35% open.

As further illustrated in FIG. 1, the corn mover 120 is an auger positioned within the channel 132. In some embodiments, the auger 120 is rotatable to move ingredients through the channel 132 from the first end 110 toward the second 112 of the housing 102 and/or from second end 112 toward the first end 110. For example, in the illustrated embodiment, the auger 120 can have a longitudinal axis L and can be rotatable (i) in a first direction RF about the longitudinal axis L to move ingredients in a first direction (e.g., from the first end 110 toward the second end 112) and (ii) in a second direction RR about the longitudinal axis L to move ingredients in a second direction, opposite the first direction. In certain embodiments, the auger 120 is operably coupled to a motor (not shown; via, e.g., one or more belts and/or pulleys) configured to drive rotation of the auger 120.

The popcorn machine 100 can further include an inlet assembly (e.g., a hopper assembly) 140 coupled to the first end 110 of the housing 102 and configured to load ingredients (e.g., unpopped kernels of corn), and an outlet assembly (e.g., a discharge assembly) 150 coupled to the second end 112 of the housing 102 and configured to dispense the popped ingredients (e.g., popped popcorn). More particularly, in the illustrated embodiment, the inlet assembly 140 includes a hopper 142 having a removable lid 144. In operation, the lid 144 can be removed and unpopped ingredients may be poured or otherwise loaded into the hopper 142. The inlet assembly 140 can direct the unpopped ingredients through the first end 110 (e.g., through an opening 107 in the second side cover 103b) of the housing 102 and into the channel 132. The outlet assembly 150 includes a removable upper cover (not pictured in FIG. 1 for clarity of illustration) and an outlet (e.g., discharge) chute 154. In operation, the auger 120 can be rotated to move popped ingredients from the channel 132 through the second end 112 (e.g., through an opening 109 in the third side cover 103c) of the housing 102 and into the outlet assembly 150, where the popped ingredients are dispensed through the outlet chute 154.

In the illustrated embodiment, the popcorn machine 100 further includes a bearing assembly cover 114 which, as described in further detail below, at least partially encases and/or hides a bearing assembly that is operatively coupled to a motor. In some embodiments, the popcorn machine 100 is portable or mobile. For example, the popcorn machine 100 can include one more lockable rollers (not pictured in FIG. 1; e.g., casters, wheels, etc.) to allow the popcorn machine 100 to be moved or wheeled to different locations for use.

FIG. 2 is a cross-sectional, isometric, side view of the popcorn machine 100 configured in accordance with an embodiment of the present technology. FIG. 3 is a side view of the popcorn machine 100 with the second side cover 103b (FIG. 1) removed for clarity of illustration. Referring to FIGS. 2 and 3 together, the housing 102 encloses an air mover 260 (e.g., an axial fan, plug fan, centrifugal fan, high velocity fan, etc.), and a heat source 270 (e.g., an electrical heating element, gas burner, etc.), among other components. In the illustrated embodiment, the auger 120 is mounted on a shaft 221. In some embodiments, the auger 120 and/or the shaft 221 can have different relative sizes, the auger 120 can have a greater pitch, a finer pitch, segments with different pitches, etc., and/or the shaft 221 can have an outer diameter of varying size. In the illustrated embodiment, the trough 130 has a generally U-shape and can be fixedly coupled to (e.g., attached to) the housing 102.

In some embodiments, the auger 120 is rotatably positioned proximate a bottom portion 233 of the trough 130. More specifically, an outer diameter of the auger 120 can be about the same as, but slightly less than, a diameter of the bottom portion 233 of the trough 130 such that there is relatively little clearance between the auger 120 and the bottom portion 233 of the trough 130. In certain embodiments, the distance between the auger 120 and the bottom portion 233 of the trough 130 is less than a minimum dimension of ingredients to be added to the popcorn machine 100 to facilitate movement of the ingredients through the trough 130. For example, in certain embodiments, the distance between the auger 120 and the bottom portion 233 of the trough 130 can be less than about an average diameter, minimum diameter, etc., of an unpopped corn kernel.

In the embodiment illustrated in FIG. 2, the popcorn machine 100 includes a drive assembly 280 that drives the air mover 260. The air mover 260 is mounted on a support shaft 262 extending laterally across the housing 102. More specifically, a first end portion 263 of the support shaft 262 is supported by a first bearing assembly 266 at a first side 208a of the housing 102, and an opposite second end portion 264 of the support shaft 262 is supported by a second bearing assembly 268 at a second side 208b of the housing 102. The first bearing assembly 266 and the second bearing assembly 268 are configured to support the support shaft 262 and allow the support shaft 262 to rotate about its longitudinal axis to drive the air mover 260 (e.g., to drive a plurality of blades, not pictured in FIG. 2 for clarity of illustration). In the illustrated embodiment, the first bearing assembly 266 and the second bearing assembly 268 are each attached to an exterior surface of the housing 102. In other embodiments, however, the first bearing assembly 266 and the second bearing assembly 268 can be located at other positions, including, for example, inside the housing 102, integral with the housing 102, etc. In still further embodiments, the support shaft 262 can be cantilevered from a side portion of the housing 102. Moreover, as shown in the illustrated embodiment, the longitudinal (e.g., rotational) axis of the support shaft 262 extends in a direction that is generally perpendicular to a longitudinal (e.g., rotational) axis of the shaft 221 of the auger 120.

In the illustrated embodiment, the first end portion 263 of the support shaft 262 extends outwardly beyond the first bearing assembly 266 and is operably coupled to a first pulley 282. A chain or belt 284 operably couples the first pulley 282 to a second pulley 286. The second pulley 286 is coupled to (e.g., carried by) a drive shaft 288 extending from and operably coupled to a motor 289. As a result, in operation, the motor 289 rotates the second pulley 286, which drives the first pulley 282 via the belt 284. In the illustrated embodiment, the motor 289 is attached to a lower portion of the housing 102. In other embodiments, however, the motor 289 can be positioned in other locations. For example, the motor 289 can be positioned on the side of the housing 102 above, below, or laterally spaced apart from the first bearing assembly 266. In still further embodiments, the motor 289 can be operably coupled directly to the first end portion 263 of the support shaft 262 to drive the support shaft 262 without the use of the first pulley 282, the belt 284, and/or the second pulley 286.

As best seen in FIG. 3, the interior of the housing 102 is separated into a first side portion 391 and a second side portion 392 by a first partition member (e.g., a divider) 393a extending longitudinally through the housing 102. The heat source 270 is mounted inside the housing 102 in the first side portion 391, and the air mover 260 is mounted in the second side portion 392. In the illustrated embodiment, an air intake portion 361 of the air mover 260 extends through a portion of the first partition member 393a to draw air from the first side portion 391. The trough 130 and the auger 120 are positioned above the air mover 260 and over a slot (e.g., an opening) 394 extending longitudinally through the housing 102. The slot 394 is formed between a second partition member 393b spaced apart from a third partition member 393c. More particularly, the second partition member 393b extends from the first partition member 393a, and the third partition member 393c extends from a side portion of the housing 102.

In operation, the trough 130 can act as a fluidized bed dryer when heated air is forced through the trough 130 to pop ingredients (e.g., corn kernels). In particular, the auger 120 can be rotated as described in detail above to move ingredients through the channel 132 over the slot 394. As the corn kernels are moved over the slot 394, the air mover 160 forces heated air through the slot 394 to pop the corn kernels. More specifically, the heat source 270 heats the surrounding air in the first side portion 391 of the housing 102. In some embodiments, the air is heated to between about 420-450 degrees Fahrenheit (e.g., about 435 degrees Fahrenheit). In other embodiments, however, the air can be heated to be more or less than about 435 degrees Fahrenheit. The air mover 260 draws the heated air, indicated by arrow 396, from the first side portion 391 through the air intake portion 361 and forces the heated air, indicated by arrow 397, from the second side portion 392 through the slot 394 and then through the perforations in the trough 130. As the heated air passes into the channel 132 through the trough 130, corn kernels on the bottom of the trough 130 are lifted and agitated by the force of the air and behave like a fluid. The high velocity of the heated air provides a very high heat transfer rate for popping the kernels. The heated air can then pass through the perforations in the trough 130 and into first side portion 391. That is, after the air passes at least partially through the channel 132, indicated by arrow 398, the air returns to the first side portion 391 of the housing 102 and can again travel by the heat source 270 and into the air intake portion 361 of the air mover 260.

Referring to FIGS. 1-3 together, the trough 130 is not fixed to the auger 120 and does not extend around an upper portion of the auger 120. Accordingly, when the upper cover 104 is removed from the popcorn machine 100, the channel 132 and auger 120 are visible and can be easily inspected and cleaned. In contrast, some popcorn machines include a popping drum having an auger and a perforated metal sheet or screen that is fixedly attached (e.g., welded) to the auger. In such popcorn machines, the metal sheet or screen fully surrounds and rotates with the auger and, accordingly, it is difficult to clean and/or inspect the auger and/or other assembled components of the popping drum. The present technology advantageously allows for easy inspection and/or cleaning of the auger 120, the trough 130, and/or other components of the popcorn machine 100.

From the foregoing, it will be appreciated that specific embodiments have been described herein for purposes of illustration, but that various modifications may be made without deviating from the spirit and scope of the present technology. Those skilled in the art will recognize that numerous modifications or alterations can be made to the components or systems disclosed herein. Moreover, certain aspects of the present technology described in the context of particular embodiments may be combined or eliminated in other embodiments. Further, while advantages associated with certain embodiments have been described in the context of those embodiments, other embodiments may also exhibit such advantages, and not all embodiments need necessarily exhibit such advantages to fall within the scope of the present technology. Accordingly, the inventions are not limited except as by the appended claims.

I/we claim:

1. A popcorn machine comprising:
a housing;
a trough positioned at least partially within the housing;
an auger positioned at least partially within the trough, wherein the auger is rotatable relative to the trough to move ingredients through the trough;
a heat source configured to heat air in the housing; and
an air mover configured to direct heated air from the heat source through the trough to heat the ingredients in the trough.

2. The popcorn machine of claim 1 wherein the trough is fixedly coupled to the housing.

3. The popcorn machine of claim 1 wherein the trough has a generally U-shape.

4. The popcorn machine of claim 1 wherein the housing includes a removable cover.

5. The popcorn machine of claim 4 wherein the trough defines a channel, wherein the auger extends at least partially through the channel, and wherein the cover is removable to provide access to the channel and/or to the auger.

6. The popcorn machine of claim 4 wherein the cover is removable to permit inspection and/or cleaning of the auger.

7. The popcorn machine of claim 4 wherein the cover is removable to permit inspection and/or cleaning of the trough.

8. The popcorn machine of claim 1 wherein the auger has an outside diameter that is approximately the same as, but less than, a diameter of a bottom portion of the trough.

9. The popcorn machine of claim 1 wherein the trough is perforated to permit the passage of heated air therethrough.

10. A popcorn machine, comprising:
a housing;
a perforated trough fixedly positioned within the housing;
a corn mover positioned at least partially within the trough and configured to move corn kernels through the trough;
a heat source positioned within the housing and spaced apart from the corn mover; and
an air mover positioned in the housing and configured to direct heated air from the heat source toward the corn kernels in the trough.

11. The popcorn machine of claim 10 wherein the housing includes a removable upper cover.

12. The popcorn machine of claim 11 wherein the upper cover is removable to provide access to the trough and the corn mover.

13. The popcorn machine of claim 11 wherein the upper cover is removable to permit inspection of and/or cleaning of the trough and the corn mover.
